(19) United States
(12) Patent Application Publication
(10) Pub. No.: US 2024/0078350 A1
(43) Pub. Date: Mar. 7, 2024

(54) SYSTEMS AND METHODS FOR EMPLOYING A DISTRIBUTED COMPUTER-AIDED DESIGN (CAD) SYSTEM TO MANAGE THE DESIGN OF A MANUFACTURING FACILITY

(71) Applicant: Ford Global Technologies, LLC, Dearborn, MI (US)

(72) Inventor: Steven Schuchard, Farmington Hills, MI (US)

(73) Assignee: Ford Global Technologies, LLC, Dearborn, MI (US)

(21) Appl. No.: 17/939,503

(22) Filed: Sep. 7, 2022

(51) Int. Cl. G06F 30/12

(52) U.S. Cl. CPC G06F 30/12; G06F 2111/02

(57) ABSTRACT

A distributed CAD system includes a server computing device comprising a reference CAD object database and a workstation database. The reference CAD object database comprises a plurality of reference CAD objects, and the workstation database includes a plurality of workstation entries. The distributed CAD system includes a plurality of client computing devices. Each client computing device from among the plurality of client computing devices comprises a client database, and the client database comprises one or more local CAD files and one or more local properties associated with each of the one or more local CAD files. Each client computing device is configured to: select a given local CAD file, identify a given workstation entry associated with the given local CAD file, selectively modify a set of one or more master properties defined by the given workstation entry and a set of the location-based information defined by the given workstation entry.

### FIELD

The present disclosure relates to employing a distributed CAD system to manage the design of a manufacturing facility.

### BACKGROUND

The statements in this section merely provide background information related to the present disclosure and may not constitute prior art.

In a manufacturing environment, CAD modeling software aids in the creation, modification, analysis, and/or enhancement of the design of, for example, finished workpieces (e.g., vehicles or components thereof), manufacturing processes, and/or equipment employed to fabricate the finished workpieces. Different manufacturing entities may utilize various versions and/or types of the CAD modeling software, and a given manufacturing entity may have CAD modeling software that is not able to interpret, view, and/or modify CAD files generated by another manufacturing entity. As an example, a given entity may not collaborate with other entities to view and/or modify a CAD file due to, for example, native CAD modeling software types that provide the information as metadata without any CAD objects. This issue with CAD modeling software, among other issues, is addressed by the present disclosure.

### SUMMARY

This section provides a general summary of the disclosure and is not a comprehensive disclosure of its full scope or all of its features.

The present disclosure provides a distributed CAD system comprising a server computing device comprising a reference CAD object database and a workstation database. The reference CAD object database comprises a plurality of reference CAD objects, and the workstation database includes a plurality of workstation entries. Each workstation entry from among the plurality of workstation entries defines one or more master properties associated with a set of the reference CAD objects from among the plurality of reference CAD objects and location-based information of a workstation within a manufacturing environment. The one or more master properties include one or more tools associated with the workstation, one or more workpieces associated with the workstation, or a combination thereof. The distributed CAD system includes a plurality of client computing devices communicably coupled to the server computing device. Each client computing device from among the plurality of client computing devices comprises a client database, and the client database comprises one or more local CAD files and one or more local properties associated with each of the one or more local CAD files. Each client computing device from among the plurality of client computing devices is configured to: select a given local CAD file from among the one or more CAD files, identify a given workstation entry from among the plurality of workstation entries associated with the given local CAD file, selectively modify a set of one or more master properties defined by the given workstation entry based on a comparison between the set of one or more master properties and a set of one or more local properties associated with the given local CAD file, and selectively modify a set of the location-based information defined by the given workstation entry based on a comparison between the set of the location-based information and a set of one or more local location-based information associated with the given local CAD file.

In one form, each reference CAD object from among the plurality of reference CAD objects is associated with one or more CAD graphic formats. In one form, the one or more CAD graphic formats includes a two-dimensional (2D) graphic type, a three-dimensional (3D) graphic type, an augmented reality graphic type, a virtual reality graphic type, or a combination thereof. In one form, the location-based information of the workstation is further based on an area of the workstation, a perimeter of the workstation, position coordinates of the workstation, or a combination thereof. In one form, selectively modifying the set of one or more master properties defined by the given workstation entry based on the comparison further comprises adding additional tools from among the one or more tools, additional workpieces from among the one or more workpieces, or a combination thereof associated with the given workstation entry.

In one form, selectively modifying the set of one or more master properties defined by the given workstation entry based on the comparison further comprises replacing a set of tools from among the one or more tools, a set of workpieces from among the one or more workpieces, or a combination thereof associated with the given workstation entry. In one form, selectively modifying the set of one or more master properties defined by the given workstation entry based on the comparison further comprises deleting a set of tools from among the one or more tools, a set of workpieces from among the one or more workpieces, or a combination thereof associated with the given workstation entry. In one form, selecting the given local CAD file is further based on an input received by a given client computing device from among the plurality of client computing devices. In one form, the server computing device and the plurality of client computing devices are communicably coupled by an application programming interface (API). In one form, the plurality of workstation entries are stored as text-based files. In one form, the text-based files are comma-separated values (CSV) files.

The present disclosure provides a method for managing a distributed CAD system comprising a server computing device communicably coupled to a plurality of client computing devices, where the server computing device comprises a reference CAD object database and a workstation database, where each client computing device from among the plurality of client computing devices comprises a client database, and where the client database comprises the one or more local CAD files defining one or more local properties associated with each of the one or more local CAD files and location-based information associated with each of the one or more local CAD files. The method includes determining, by the server computing device, whether an input received by a given client computing device from among the plurality of client computing devices satisfies a file comparison condition. The reference CAD object database comprises a plurality of reference CAD objects, the workstation database includes a plurality of workstation entries, each workstation entry from among the plurality of workstation entries defines one or more master properties associated with a set of the reference CAD objects from among the plurality of reference CAD objects and location-based information of a workstation within a manufacturing environment, and the one or more master properties include one or more tools associated with the workstation, one or more workpieces associated with the workstation, or a combination thereof. The method includes selecting, by the server computing device and in response to the input satisfying the file comparison condition, select a given local CAD file from among the one or more CAD files and identifying, by the server computing device and in response to the input satisfying the file comparison condition, a given workstation entry from among the plurality of workstation entries associated with the given local CAD file. The method includes selectively modifying, by the server computing device and in response to the input satisfying the file comparison condition, a set of one or more master properties defined by the given workstation entry based on a comparison between the set of one or more master properties and a set of one or more local properties associated with the given local CAD file. The method includes selectively modifying, by the server computing device and in response to the input satisfying the file comparison condition, a set of location-based information defined by the given workstation entry based on a comparison between the location-based information and a set of location-based information associated with the given local CAD file.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a functional block diagram of a distributed CAD system in accordance with the teachings of the present disclosure;

FIG. 2 is a functional block diagram of a distributed CAD system in accordance with the teachings of the present disclosure; and

FIG. 3 is a flowchart of an example control routine in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a distributed CAD system that enables various entities (e.g., vendors, manufacturing facilities, administrators, among other entities) to collaboratively view, create, modify, and delete CAD files in real time via an application programming interface that connects a server computing device and a plurality of client computing devices. More specifically, the distributed CAD system includes one or more modules that enable an entity to view, create, modify, and delete CAD files regardless of the CAD modeling software types and/or versions being executed by the entity. More specifically, the distributed CAD system employs text-based files having metadata that is agnostic to the type and/or version of CAD modeling software to compare CAD data stored by a server computing device and a client computing device. As such, the distributed CAD system enables an entity to selectively modify local CAD data and/or master CAD data within a distributed CAD system in a manner that is agnostic to the CAD modeling software type and/or version.

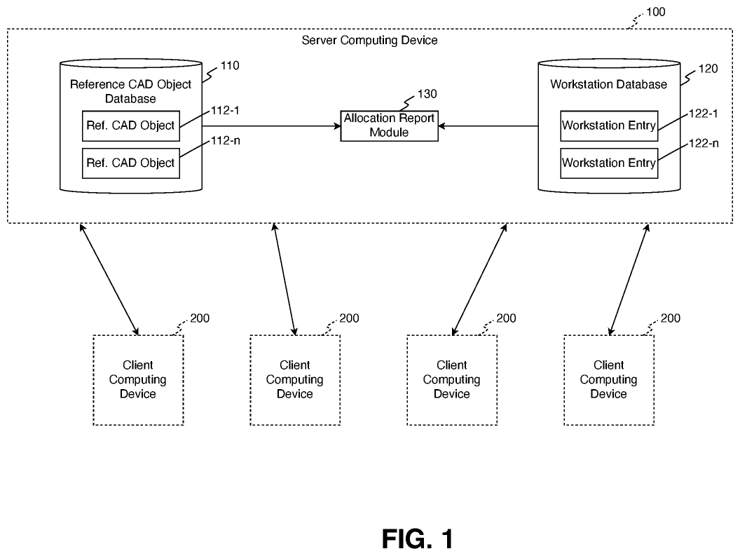

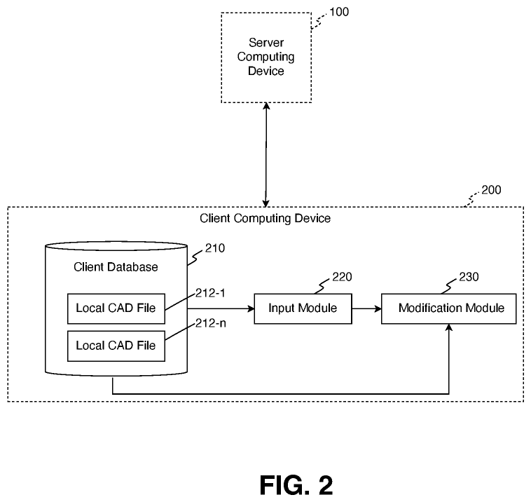

Referring to FIGS. 1-2, a distributed CAD system 10 that is provided in, for example, one or more manufacturing environments is shown. In one form, the distributed CAD system 10 includes a server computing device 100 and a plurality of client computing devices 200-1, 200-2, 200-3, . . . 200-n (collectively referred to hereinafter as “client computing devices 200”). In one form, the server computing device 100 and the client computing devices 200 are communicably coupled using a wired and/or wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others). In one form, each of the client computing devices 200 may be associated with a given manufacturing entity among one or more manufacturing entities.

In one form, the server computing device 100 and the client computing devices 200 are communicably coupled to each other via an application programming interface (API) that is uniquely defined for the server computing device 100 and the client computing devices 200. As an example, the API may include one or more server tags that communicably couple the server computing device 100 and the client computing devices 200 to a remote server (e.g., a JAVA® JavaServer, Python® client server, among other servers) via a transmission control protocol (TCP) socket and thereby enables communication between the server computing device 100 and the client computing devices 200.

In one form, the server computing device 100 includes a reference CAD object database 110, a workstation database 120, and an allocation report module 130. In one form, the reference CAD object database 110 comprises a plurality of reference CAD objects 112-1, . . . 112-n (collectively referred to hereinafter as “reference CAD objects 112”). The reference CAD objects are CAD objects that facilitate component or workstation design in a manufacturing environment (e.g., a vehicle manufacturing environment) when, for example, a user of the client computing devices 200 is executing CAD modeling software. As an example, the reference CAD objects 112 may correspond to tools, fixtures, workpieces (e.g., a vehicle and/or vehicle component), robots (e.g., autonomous robots, stationary robots, among other robot types), conveyors, storage racks, pallets, machinery, operators, sensors, vehicles (e.g., automated guided vehicles), and/or other components of a manufacturing environment.

The reference CAD objects 112 may have various CAD graphic formats, such as a two-dimensional (2D) graphic type, a three-dimensional (3D) graphic type, an augmented reality graphic type, a virtual reality graphic type, or a combination thereof. In one form, the reference CAD object database 110 stores the reference CAD objects 112 in a neutral format that can be interpreted by any type of CAD modeling software executed by the client computing devices 200, such as CATIA V5, AutoStudio, NX, or other types of CAD modeling software. As an example, the reference CAD objects 112 are provided by Standard for the Exchange of Product Data (STEP) files, Initial Graphics Exchange Specification (IGES) files, among other neutral formats.

In one form, the workstation database 120 comprises one or more workstation entries 122-1, . . . 122-n (collectively referred to hereinafter as “workstation entries 122”). Each of the workstation entries 122 defines one or more master properties. As used herein, “master properties” refers to CAD objects of the workstation entries 122 that are employed in workstation design and one or more properties associated with the CAD objects. As an example, the master properties define the tools, fixtures, workpieces, robots, conveyors, storage racks, pallets, machinery, operators, sensors, vehicles, assembly instructions, and/or other components associated with the workstation. Furthermore, the properties may define any physical and/or material properties associated with the CAD objects, such as dimensions, size, volume, area, surface geometries, surface characteristics, among various other types of physical or material properties. It should be understood that the property of the CAD objects may include other types of physical and material properties and are not limited to the examples described herein.

Furthermore, the one or more master properties may define location-based information of a workstation and/or the components thereof within the manufacturing environment. As an example, the location-based information may define an area of the workstation, a perimeter of the workstation, position coordinates of the workstation (e.g., 2D/3D indoor positioning system (IPS) position coordinates and/or 2D/3D global navigation satellite system (GNSS) position coordinates), an outline of the workstation, dimensions of the workstation, or a combination thereof.

Additionally, each of the workstation entries 122 includes master identification information. As used herein, the “master identification information” refers to identifying indicia associated with the CAD objects defined by the master properties. In one form, each of the CAD objects is assigned to a unique identification text string that is interpretable by each of the client computing devices 200 regardless of the type and/or version of CAD modeling software executed by the client computing devices 200 (i.e., the master identification information is agnostic). As an example, a first tool of the workstation entry 122 has the unique identification string “SB43,” a second tool of the workstation entry 122 has the unique identification string “SB97,” a robot of the workstation entry 122 has the unique identification string “AX71,” and a workpiece of the workstation entry 122 has the unique identification string “BC23.” It should be understood that the master identification information of the CAD objects may include other types of text strings and/or identifying indicia and is not limited to the examples described herein.

In one form, the workstation entries 122 are stored as text files, such as a comma-separated values (CSV) file. As an example, the workstation entries 122 (and the corresponding master properties, location-based information, and master identification information) are stored as a CSV file that is configured to be viewed and/or modified by Microsoft® Excel or other type of spreadsheet software. As described below in further detail, the allocation report module 130 is configured to transmit an allocation report associated with a given workstation entry 122 to the client computing devices 200 to thereby agnostically identify and/or modify local CAD files stored on the client computing devices 200.

In one form, each of the client computing devices 200 includes a client database 210, an input module 220, and a modification module 230. The client database 210 comprises one or more local CAD files 212-1, . . . 212-n (collectively referred to hereinafter as “local CAD files 212”). Each of the local CAD files 212 defines local properties. As used herein, “local properties” refers to CAD objects of the local CAD files 212 that are employed in component and/or workstation design and one or more properties associated with the CAD objects. As an example, the local properties define the tools, fixtures, workpieces, robots, conveyors, storage racks, pallets, machinery, operators, sensors, vehicles, assembly instructions, and/or other components of a workstation. Furthermore, the properties may define any physical properties and/or material properties associated with the CAD objects, such as dimensions, size, volume, area, surface geometries, surface characteristics, among various other types of physical or material properties. Additionally, and similar to the master properties defined above, the local properties may define location-based information associated with the workstation and/or the components thereof.

Additionally, each of the local CAD files 212 includes local identification information. As used herein, the “local identification information” refers to identifying indicia associated with the CAD objects defined by the local properties. In one form, the local identification information is agnostic among various CAD modeling software types and versions. In one form, each of the CAD objects is assigned to a unique identification text string that is interpretable by each of the client computing devices 200 regardless of the type and/or version of CAD modeling software executed by the client computing devices 200. As an example, a first tool of the local CAD file 212 has the unique identification string “SX54,” a robot of the local CAD file 212 has the unique identification string “ZF48,” and a workpiece of the local CAD file 212 has the unique identification string “VC41.” It should be understood that the local identification information of the CAD objects may include other types of text strings and/or identifying indicia and is not limited to the examples described herein. Similar to the workstation entries 122, the local CAD files 212 may also be stored as CSV files or other text-based files.

In one form, the input module 220 includes an input device that is configured to receive inputs from an operator while executing CAD modeling software. As an example, the input device may be provided by a user interface (UI) element of a display device (e.g., a touchscreen display device, a desktop monitor, among other display devices), a joystick, a button, a keyboard, a mouse, an augmented reality input device, and/or a virtual reality input device. It should be understood that the input device may be provided by any device that is configured to receive inputs from an operator and is not limited to the examples described herein.

The input module 220 determines whether the input received by the input device from the operator satisfies a file comparison condition. As an example, the input satisfies the file comparison condition in response to the input corresponding to the client computing device 200 selecting and opening one of the local CAD files 212 while executing the CAD modeling software.

In one form, the modification module 230 instructs, in response to the file comparison condition being satisfied, the allocation report module 130 to generate and transmit an allocation report based on the given local CAD file 212 and the corresponding workstation entry 122 stored in the workstation database 120. As an example, the allocation report module 130 identifies and selects the workstation entry 122 that corresponds to the opened local CAD file 212 based on a comparison of, for example, the filename, master properties, master identification information, local properties, and/or local identification information. Subsequently, the allocation report module 130 to generate the allocation report associated with the selected workstation entry 122 (e.g., a CSV file or other text-based file).

In response to generating and transmitting the allocation report, the modification module 230 provides an interface for selectively modifying a set of the master properties defined by the selected workstation entry 122. As an example, the modification module 230 compares the text of the CSV file defining the master properties (as indicated by the allocation report) and the text of the CSV file defining the local properties (as indicated by the selected local CAD file 212) to identify differences between the workstation entry 122 and the local CAD file 212. Subsequently, the modification module 230 provides an interface (e.g., a graphic and/or text-based user interface) that enables an operator to modify the master properties to match the local properties.

Modifying the master properties includes, but is not limited to, adjusting one of the physical and/or material properties of a CAD object of the workstation entry 122, deleting a CAD object from the workstation entry 122, and/or adding a new CAD object to the workstation entry 122. As an example, modifying the master properties includes adding additional tools and/or workpieces, replacing tools and/or workpieces with new tools and/or workpieces, deleting tools and/or workpieces, or adding/replacing/deleting other components of the workstation. To modify the master properties, the interface may include one or more graphical user interface elements enabling the user to perform the modification via a text input and/or other input received by the input module 220 when executing, for example, the CAD modeling software.

Similarly, and in response to generating and transmitting the allocation report, the modification module 230 provides an interface for selectively modifying a set of the local properties defined by the local CAD file 212. As an example, the modification module 230 compares the text of the CSV file defining the master properties (as indicated by the allocation report) and the text of the CSV file defining the local properties (as indicated by the selected local CAD file 212) to identify differences between the workstation entry 122 and the local CAD file 212. Subsequently, the modification module 230 provides an interface (e.g., a graphic and/or text-based user interface) that enables an operator to modify the local properties to match the master properties of the workstation entry 122.

In one form and in response to generating the allocation report, the modification module 230 provides an interface for selectively modifying a set of location-based information defined by the selected workstation entry 122. As an example, the modification module 230 compares the location-based information of the allocation report and the location-based information of the selected local CAD file 212 to identify differences between the workstation entry 122 and the local CAD file 212. Subsequently, the modification module 230 provides an interface (e.g., a graphic and/or text-based user interface) that enables an operator to modify the location-based information of the workstation entry 122 to match the location-based information of the local CAD file 212. Similarly, and in another form, the modification module 230 may provide an interface for selectively modifying a set of location-based information defined by the local CAD file 212 to match the location-based information defined by the workstation entry 122.

Modifying the location-based information includes, but is not limited to, adjusting an area of the workstation, a perimeter of the workstation, position coordinates of the workstation, an outline of the workstation, dimensions of the workstation, or a combination thereof. To modify the location-based information, the interface may include one or more graphical user interface elements enabling the user to perform the modification via a text input and/or other input received by the input module 220 when executing, for example, the CAD modeling software.

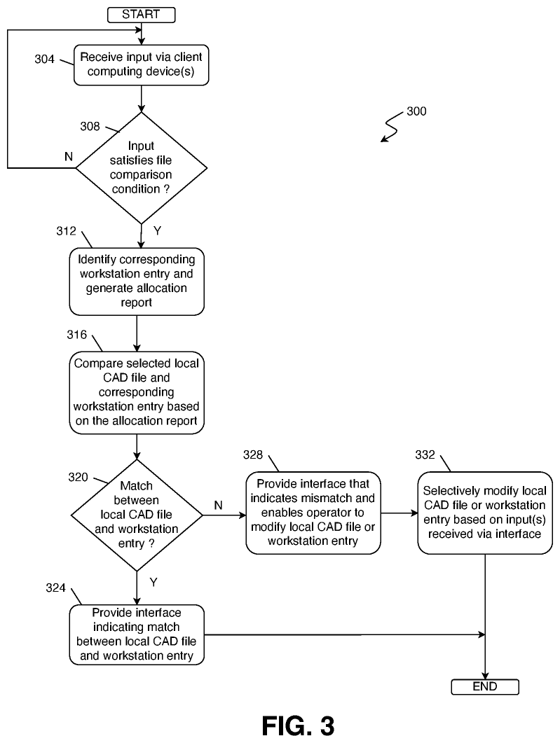

Referring to FIG. 3, a flowchart illustrating an example routine 300 for managing the distributed CAD system 10 is shown. At 304, the distributed CAD system 10 receives inputs via one of the client computing devices 200. At 308, the client computing device 200 determines whether the input satisfies a file comparison condition. If the input satisfies the file comparison condition, the routine 300 proceeds to 312. Otherwise, if the input does not satisfy the file comparison condition, the routine 300 proceeds to 304.

At 312, the server computing device 100 or the client computing device 200 identifies the corresponding workstation entry, and the server computing device 100 generates the allocation report based on the corresponding workstation entry. At 316, the client computing device 200 compares the selected local CAD file 212 and the corresponding workstation entry 122 based on the allocation report.

At 320, the client computing device 200 determines whether the allocation report indicates a match between the local CAD file 212 and the workstation entry 122. If the allocation report indicates a match, the routine 300 proceeds to 324, where the client computing device 200 provides an interface indicating a match between the local CAD file 212 and the workstation entry 122 (e.g., an interface including text, graphics, or other user interface elements of the CAD modeling software indicating a match).

Otherwise, if the allocation report does not indicate a match at 320, the routine 300 proceeds to 328, where the client computing device 200 provides an interface that indicates a mismatch between the local CAD file 212 and the workstation entry 122 and that enables the operator to modify the local CAD file 212 or the workstation entry 122. At 332, the client computing device 200 selectively modifies the local CAD file 212 or the workstation entry 122 based on one or more inputs received via the interface.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A distributed computer-aided design (CAD) system comprising:
a server computing device comprising a reference CAD object database and a workstation database, wherein:
the reference CAD object database comprises a plurality of reference CAD objects;
the workstation database includes a plurality of workstation entries;
each workstation entry from among the plurality of workstation entries defines one or more master properties associated with a set of the reference CAD objects from among the plurality of reference CAD objects and location-based information of a workstation within a manufacturing environment; and
the one or more master properties include one or more tools associated with the workstation, one or more workpieces associated with the workstation, or a combination thereof; and
a plurality of client computing devices communicably coupled to the server computing device, wherein:
each client computing device from among the plurality of client computing devices comprises a client database;
the client database comprises one or more local CAD files, one or more local properties associated with each of the one or more local CAD files, and location-based information associated with each of the one or more local CAD files; and
each client computing device from among the plurality of client computing devices is configured to:
select a given local CAD file from among the one or more CAD files;
identify a given workstation entry from among the plurality of workstation entries associated with the given local CAD file;
selectively modify a set of one or more master properties defined by the given workstation entry based on a comparison between the set of one or more master properties and a set of one or more local properties associated with the given local CAD file; and
selectively modify a set of the location-based information defined by the given workstation entry based on a comparison between the set of the location-based information and a set of one or more local location-based information associated with the given local CAD file.

2. The distributed CAD system of claim 1, wherein each reference CAD object from among the plurality of reference CAD objects is associated with one or more CAD graphic formats.

3. The distributed CAD system of claim 2, wherein the one or more CAD graphic formats includes a two-dimensional (2D) graphic type, a three-dimensional (3D) graphic type, an augmented reality graphic type, a virtual reality graphic type, or a combination thereof.

4. The distributed CAD system of claim 1, wherein the location-based information is further based on an area of the workstation, a perimeter of the workstation, position coordinates of the workstation, or a combination thereof.

5. The distributed CAD system of claim 1, wherein selectively modifying the set of one or more master properties defined by the given workstation entry based on the comparison further comprises adding additional tools from among the one or more tools, additional workpieces from among the one or more workpieces, or a combination thereof associated with the given workstation entry.

6. The distributed CAD system of claim 1, wherein selectively modifying the set of one or more master properties defined by the given workstation entry based on the comparison further comprises replacing a set of tools from among the one or more tools, a set of workpieces from among the one or more workpieces, or a combination thereof associated with the given workstation entry.

7. The distributed CAD system of claim 1, wherein selectively modifying the set of one or more master properties defined by the given workstation entry based on the comparison further comprises deleting a set of tools from among the one or more tools, a set of workpieces from among the one or more workpieces, or a combination thereof associated with the given workstation entry.

8. The distributed CAD system of claim 1, wherein selecting the given local CAD file is further based on an input received by a given client computing device from among the plurality of client computing devices.

9. The distributed CAD system of claim 1, wherein the server computing device and the plurality of client computing devices are communicably coupled by an application programming interface (API).

10. The distributed CAD system of claim 1, wherein the plurality of workstation entries are stored as text-based files.

11. The distributed CAD system of claim 10, wherein the text-based files are comma-separated values (CSV) files.

12. A method for managing a distributed computer-aided design (CAD) system comprising a server computing device communicably coupled to a plurality of client computing devices, the server computing device comprising a reference CAD object database and a workstation database, each client computing device from among the plurality of client computing devices comprises a client database, the client database comprises one or more local CAD files, the one or more local CAD files defining one or more local properties associated with each of the one or more local CAD files and location-based information associated with each of the one or more local CAD files, the method comprising:
determining, by the server computing device, whether an input received by a given client computing device from among the plurality of client computing devices satisfies a file comparison condition, wherein:
the reference CAD object database comprises a plurality of reference CAD objects;
the workstation database includes a plurality of workstation entries;
each workstation entry from among the plurality of workstation entries defines one or more master properties associated with a set of the reference CAD objects from among the plurality of reference CAD objects and location-based information of a workstation within a manufacturing environment; and
the one or more master properties include one or more tools associated with the workstation, one or more workpieces associated with the workstation, or a combination thereof; and
selecting, by the server computing device and in response to the input satisfying the file comparison condition, select a given local CAD file from among the one or more CAD files;
identifying, by the server computing device and in response to the input satisfying the file comparison condition, a given workstation entry from among the plurality of workstation entries associated with the given local CAD file;
selectively modifying, by the server computing device and in response to the input satisfying the file comparison condition, a set of one or more master properties defined by the given workstation entry based on a comparison between the set of one or more master properties and a set of one or more local properties associated with the given local CAD file; and
selectively modifying, by the server computing device and in response to the input satisfying the file comparison condition, a set of location-based information defined by the given workstation entry based on a comparison between the location-based information and a set of location-based information associated with the given local CAD file.

13. The method of claim 12, wherein each reference CAD object from among the plurality of reference CAD objects is associated with one or more CAD graphic formats.

14. The method of claim 13, wherein the one or more CAD graphic formats includes a two-dimensional (2D) graphic type, a three-dimensional (3D) graphic type, an augmented reality graphic type, a virtual reality graphic type, or a combination thereof.

15. The method of claim 12, wherein the location-based information is further based on an area of the workstation, a perimeter of the workstation, position coordinates of the workstation, or a combination thereof.

16. The method of claim 12, wherein selectively modifying the set of one or more master properties defined by the given workstation entry based on the comparison further comprises adding additional tools from among the one or more tools, additional workpieces from among the one or more workpieces, or a combination thereof associated with the given workstation entry.

17. The method of claim 12, wherein selectively modifying the set of one or more master properties defined by the given workstation entry based on the comparison further comprises replacing a set of tools from among the one or more tools, a set of workpieces from among the one or more workpieces, or a combination thereof associated with the given workstation entry.

18. The method of claim 12, wherein selectively modifying the set of one or more master properties defined by the given workstation entry based on the comparison further comprises deleting a set of tools from among the one or more tools, a set of workpieces from among the one or more workpieces, or a combination thereof associated with the given workstation entry.

19. The method of claim 12, wherein selecting the given local CAD file is further based on an input received by a given client computing device from among the plurality of client computing devices.

20. The method of claim 12, wherein the plurality of workstation entries are stored as text-based files.
